(19) United States
(12) Patent Application Publication
(10) Pub. No.: US 2017/0055488 A1
(43) Pub. Date: Mar. 2, 2017

(54) TELESCOPIC FOLDING TYPE PET CAGE DOOR

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/246,490

(22) Filed: Aug. 24, 2016

(30) Foreign Application Priority Data
Aug. 24, 2015 (CN) 201520644435.X

(51) Int. Cl. A01K 1/02; E05C 19/12; E06B 3/48; E06B 11/02; E05B 65/00; E05D 15/26; E05C 3/04; E05B 47/00

(52) U.S. Cl. CPC A01K 1/0245; E05C 3/04; E05C 19/12; E05B 47/0002; E06B 11/021; E06B 11/022; E05B 65/0085; E05D 15/262; E06B 3/483; E05D 2015/268

(57) ABSTRACT

A telescopic folding type pet cage door includes a lockset (1), a rotating handle (2), a locking rod (3) and guide rails (4). The pet cage door includes at least three folding units in a vertical direction, wherein the three folding units can be folded in sequence, and both ends of each folding unit are capable of sliding along the guide rails (4). The bottom folding unit is connected with a vertical lifting rod, a rotating handle (2) is disposed on the top of the lifting rod, a hook (2a) configured to hook the locking rod (3) is disposed on the end portion of the rotating handle (2), and when the hook (2a) hooks the locking rod (3), the lockset (1) carries out rotary locking on the rotary handle (2); and the lockset (1) is unlocked, the rotating handle (2) rotates, the hook (2a) is separated from the locking rod (3), the rotating handle (2) drives the lifting rod to move upwards or transversely, and the lifting rod drives the at least three folding units to be sequentially folded upwards or transversely.

### CROSS-REFERENCE TO RELATED APPLICATIONS

This Application claims the priority of Chinese Patent Application No. 201520644435.X, filed on Aug. 24, 2015, the disclosure of which is incorporated by reference in its entirety.

### TECHNICAL FIELD

The present invention relates to a pet cage door, in particular to a telescopic folding type pet cage door, belonging to the technical field of pet cages.

### BACKGROUND ART

Regarding the existing metal (e.g., iron) wire mesh cage for pet raising, a door capable of being opened and closed is disposed on one side of the cage, and the door is generally of a rotating type or a sliding type; regardless of the rotating type or the sliding type, the door is generally locked via a bolt; during use, the bolt is capable of moving left and right or up and down in need of manpower, and is thus inconvenient to operate, and is relatively laborious to operate especially in case that the iron wire mesh cage is rusted a litter or insufficient to lubricate. In addition, as an independent part, the bolt is not integrated with the whole pet cage and is even separated from an iron wire hole sometimes, and the phenomenon of bolt lost brings unnecessary troubles to users.

In the meantime, the existing sliding type pet cage door has a relatively low safety level to prevent a pet from escaping from a cage, and the phenomenon that the pet opens the cage and escapes from the cage will occasionally happens.

### SUMMARY OF THE INVENTION

The technical problem to be solved by the present invention is that: the existing sliding door of an iron wire pet cage is inconvenient to operate and relatively laborious, and a bolt may be even separated from an iron wire hole sometimes, resulting in a phenomenon of bolt lost; in the meantime, the existing sliding type pet cage door has a relatively low safety level to prevent a pet from escaping from a cage, and the phenomenon that the pet opens the cage and escapes from the cage will occasionally happens.

Objects of the present invention may be realized in the following manners:

a telescopic folding type pet cage door comprises a lockset 1, a rotating handle 2, a locking rod 3 and guide rails 4; the pet cage door comprises at least three folding units in a vertical direction, wherein the three folding units can be folded in sequence, and both ends of each folding unit are capable of sliding along the guide rails 4; the bottom folding unit is connected with a vertical lifting rod, a rotating handle 2 is disposed on the top of the lifting rod, a hook 2a configured to hook the locking rod 3 is disposed on the end portion of the rotating handle 2, and when the hook 2a hooks the locking rod 3, the lockset 1 carries out rotary locking on the rotary handle 2; and the lockset 1 is unlocked, the rotating handle 2 rotates, the hook 2a is separated from the locking rod 3, the rotating handle 2 drives the lifting rod to move upwards or transversely, and the lifting rod drives the at least three folding units to be sequentially folded upwards or transversely.

Further, the lockset 1 is an electromagnetic lockset.

Further, the guide rails 4 are square guide rails.

Further, the locking rod 3 is a crossbar fixed on the telescopic folding type pet cage door.

Further, folding units are of a rectangular structure.

Embodiments of the present invention may have one or more of the following beneficial effects:
1) the lockset is convenient to lock.
2) The rotating handle is automatically separated from the locking rod after being rotated to realize unlocking, and is very labor-saving to operate.
3) Actions of unlocking and opening the pet cage are coherent and very convenient to operate.
4) No bolt needs to be used, so that parts of the bolt are reduced and the phenomenon of lost of parts cannot happen.
5) The folding type cage door is capable of avoiding the phenomenon that the pet opens the cage and escapes from the cage, and has higher safety level.

### BRIEF DESCRIPTION OF THE DRAWINGS

FIG. 1 is a stereogram of the cage when the vertically-opened telescopic folding type pet cage door is at a closed state.

FIG. 2 is a partial enlarged drawing of FIG. 1.

FIG. 3 is a stereogram of the cage when the vertically-opened telescopic folding type pet cage door is at an opened state.

FIG. 4 is a partial enlarged drawing of FIG. 3.

FIG. 5 is a stereogram of the cage when the laterally-opened telescopic folding type pet cage door is at an closed state.

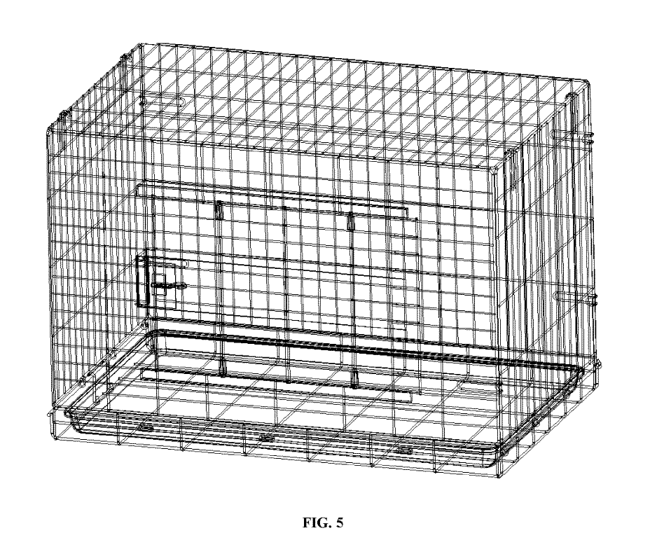

FIG. 6 is a stereogram of the cage when the laterally-opened folding type pet cage door is at an opened state.

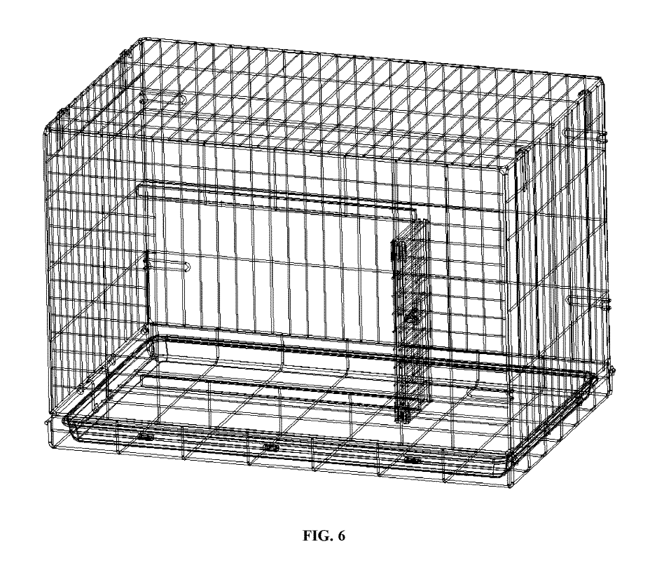

In FIGS., the lockset 1, the rotating handle 2, the locking rod 3, the guide rails 4 and the hook 2a are marked In FIGS., the spring case 1, the lifting handle 2, the chain plate 3, the crossbar 4, the guide rails 5 and the drag hook 1 a are marked.

### DETAILED DESCRIPTION

The present invention is further illustrated as below in conjunction of attached drawings and specific embodiments.

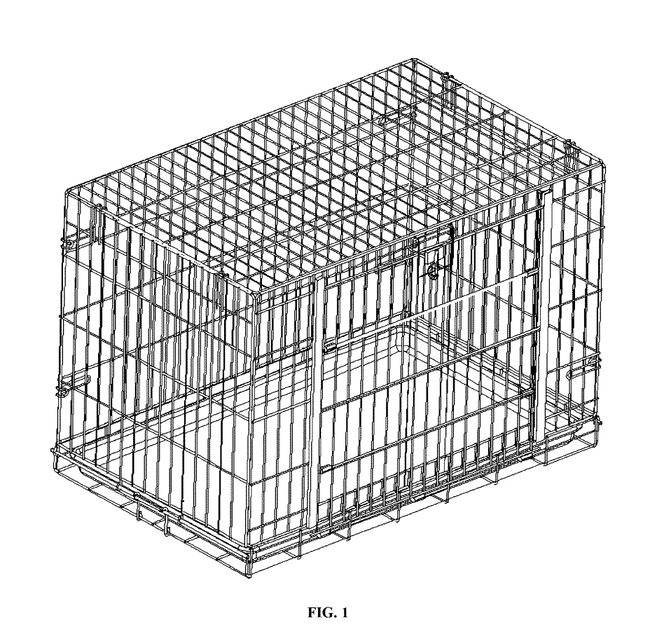

By reference to FIG. 1 to FIG. 4, a telescopic folding type pet cage door comprises a lockset 1, a rotating handle 2, a locking rod 3 and guide rails 4; the pet cage door comprises at least three folding units in a vertical direction, wherein the three folding units can be folded in sequence, and both ends of each folding unit are capable of sliding along the guide rails 4; the bottom folding unit is connected with a vertical lifting rod, a rotating handle 2 is disposed on the top of the lifting rod, a hook 2a configured to hook the locking rod 3 is disposed on the end portion of the rotating handle 2, and when the hook 2a hooks the locking rod 3, the lockset 1 carries out rotary locking on the rotary handle 2; and the lockset 1 is unlocked, the rotating handle 2 rotates, the hook 2a is separated from the locking rod 3, the rotating handle 2 drives the lifting rod to move upwards or transversely, and the lifting rod drives the at least three folding units to be sequentially folded upwards or transversely.

The lockset 1 may be an electromagnetic lockset.

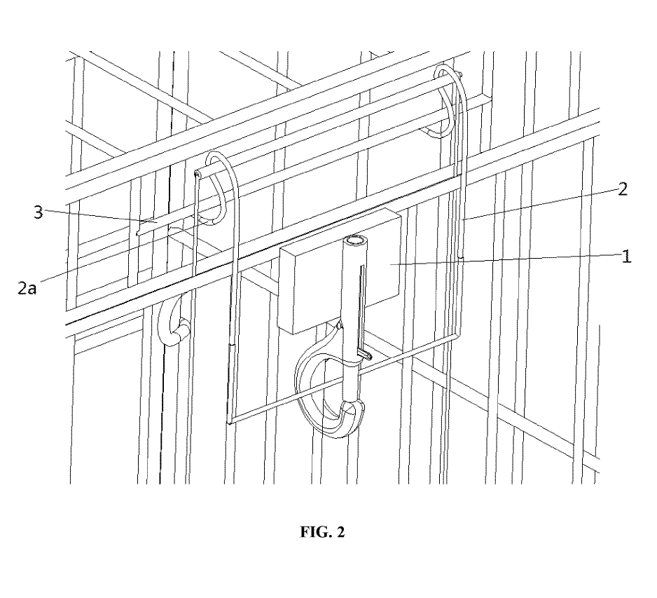

By reference to FIG. 1 to FIG. 2, the guide rails 4 may be square guide rails.

By reference to FIG. 2, the locking rod 3 may be a crossbar fixed on the telescopic folding type pet cage door.

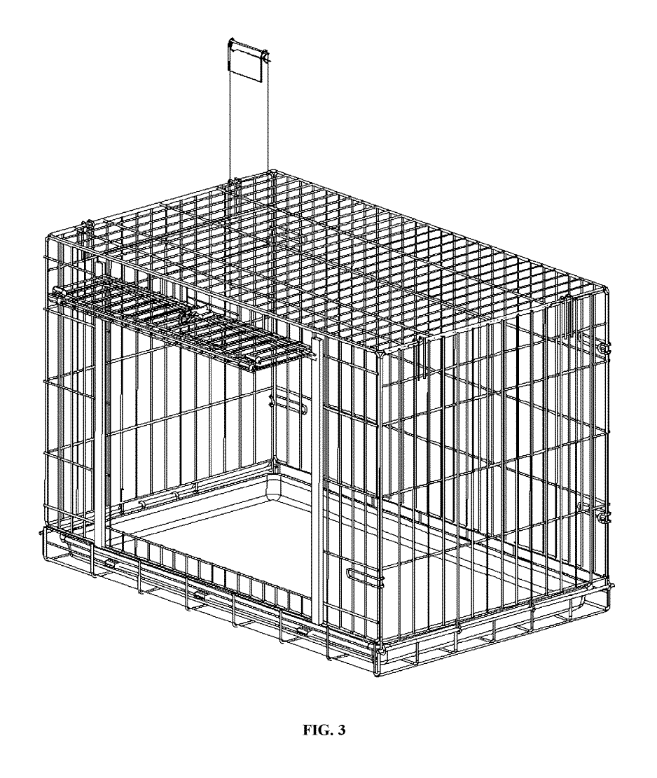

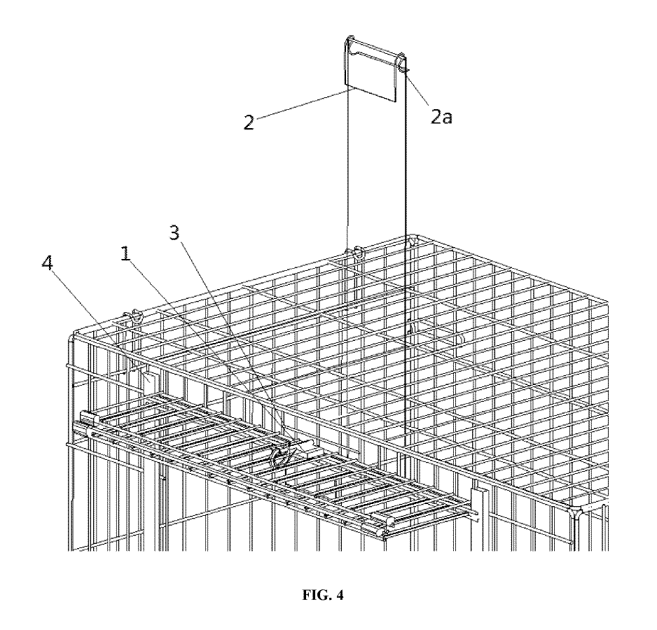

By reference to FIG. 3 to FIG. 4, folding units may be of a rectangular structure.

According to the telescopic folding type pet cage door disclosed by the present invention, the lockset is convenient to lock, the rotating handle is automatically separated from the locking rod after being rotated to realize unlocking, and is very labor-saving to operate; actions of unlocking and opening the pet cage are coherent and very convenient to operate; no bolt needs to be used, so that parts of the bolt are reduced and the phenomenon of lost of parts cannot happen; and the folding type cage door is capable of avoiding the phenomenon that the pet opens the cage and escapes from the cage, and has higher safety level.

What is claimed is:

1. A telescopic folding type pet cage door, comprising:
a lockset (1);
a rotating handle (2);
a locking rod (3); and
guide rails (4),
wherein the pet cage door comprises at least three folding units in a vertical direction, wherein the three folding units can be folded in sequence, and both ends of each folding unit are capable of sliding along the guide rails (4);
wherein the bottom folding unit is connected with a vertical lifting rod, a rotating handle (2) is disposed on the top of the lifting rod, a hook (2a) configured to hook the locking rod (3) is disposed on the end portion of the rotating handle (2), and when the hook (2a) hooks the locking rod (3), the lockset (1) carries out rotary locking on the rotary handle (2); and
wherein the lockset (1) is unlocked, the rotating handle (2) rotates, the hook (2a) is separated from the locking rod (3), the rotating handle (2) drives the lifting rod to move upwards or transversely, and the lifting rod drives the at least three folding units to be sequentially folded upwards or transversely.

2. The telescopic folding type pet cage door according to claim 1, wherein the lockset (1) is an electromagnetic lockset.

3. The telescopic folding type pet cage door according to claim 1, wherein the guide rails (4) are square guide rails.

4. The telescopic folding type pet cage door according to claim 1, wherein the locking rod (3) is a crossbar fixed on the telescopic folding type pet cage door.

5. The telescopic folding type pet cage door according to claim 1, wherein the folding units are of a rectangular structure.
